(19) United States
(12) Patent Application Publication
(10) Pub. No.: US 2017/0079745 A1
(43) Pub. Date: Mar. 23, 2017

(54) METHOD FOR PRODUCING BLANKS FOR ENDODONTIC INSTRUMENTS, AND SUCH BLANKS

(71) Applicant: Coltène/Whaledent AG, Altstätten (CH)

(72) Inventor: Werner MANNSCHEDEL, Langenau (DE)

(21) Appl. No.: 15/262,067

(22) Filed: Sep. 12, 2016

(30) Foreign Application Priority Data
Sep. 23, 2015 (EP) 15186457.6

(51) Int. Cl. A61C 5/02; B24B 19/04

(52) U.S. Cl. CPC A61C 5/023; B24B 19/04; A61C 2201/00

(57) ABSTRACT

A method for producing blanks for endodontic instruments (1), endodontic instruments (1), and a delivery device. The method comprises the steps of providing at least one rod (2) and machining the at least one rod (2) by a wire erosion such that an erosion pattern (4) is applied to the at least one rod (2). The material eroded away from the at least one rod (2) at least partially deposits as a layer on the at least one rod (2). The layer of the re-deposited material has a surface hardness which substantially corresponds to the hardness of the material of the at least one rod (2).

The invention relates to a method for producing blanks for endodontic instruments, blanks, endodontic instruments, and a delivery device.

Dentists use various types of endodontic instruments to clean and widen root channels. The dentist typically accesses the root channel through the surface of a tooth that is to be treated. Thereafter, the root channel is cleaned and widened with endodontic instruments such as files or rasps. The root channel that has been prepared in this way is filled with a filling material by the dentist and is finally sealed.

For the working of the root channel, the dentist has access to a range of flexible files that each have a handle. The files have different diameters for cleaning and widening the root canal successively. Along the length of the endodontic instrument there are typically helical and non-helical grooves or channels and cutting edges which ensure a cutting action.

Conventional endodontic instruments are produced by means of a bar being continuously twisted. In this way, cutting edges form on the surface. Alternatively, endodontic instruments are produced by means of a rod being machined in a rotating grinder. In this way, helical and non-helical grooves or notches and cutting edges are introduced along the length of the instrument. Said methods are time-consuming and cost-intensive, and only a limited number of surface configurations can be produced.

U.S. Pat. No. 6,149,501 describes a method for producing superelastic endodontic instruments, wherein a blank is present in the austenite phase of the material before being twisted. The material changes to the martensite phase during the twisting. The method comprises work steps carried out at high temperature and in liquids, which also have corroding effects on the material. The method is therefore associated with a number of disadvantages.

U.S. Pat. No. 7,207,111 B2 describes methods for producing endodontic instruments, wherein helical grooves or notches and cutting edges are formed by twisting at low temperature. Grooves or notches and cutting edges can also be introduced into the endodontic instrument by means of electrical discharge machining (EDM). Eroded material deposits again onto the instrument and has a hardness that is at least 15% greater than the hardness of the starting material. This has proven mechanically disadvantageous during the use of the instrument.

An object of the invention is to overcome the disadvantages of the prior art. In particular, it is an object of the invention to provide a method for producing blanks for endodontic instruments, by which method the blanks can be produced rapidly and cost-effectively and with advantageous properties in terms of stability and functionality.

This object is solved by the features of the independent claims.

The invention relates to a method for producing blanks for endodontic instruments. The method comprises the step of providing at least one rod, in particular with a length in the range of 1 to 15 m, preferably 2 to 10 m, particularly preferably 3 to 4 m. The method further comprises the step of machining the at least one rod by means of wire erosion, wherein an erosion pattern is applied to the at least one rod. During the machining by means of wire erosion, material is eroded away from the rod. Thus, a pattern with edges, in particular cutting edges, can be generated on the at least one rod, which pattern permits the mechanical working of a root channel. In wire erosion, the material eroded away from the at least one rod at least partially deposits again as a layer on the at least one rod. The layer of the re-deposited material has a surface hardness which substantially corresponds to the hardness of the material of the at least one rod.

The surface hardness of a layer obtained by wire erosion can be adjusted by routine measures involving suitable selection of the method parameters. In particular, the surface hardness of a layer obtained by wire erosion can be adjusted by the liquid of the erosion bath. The liquid of the erosion bath can comprise deionized water or oils, in particular mineral oils, high molecular weight hydrocarbons, silicone oils, synthetic or natural esters. Common liquids of the erosion bath, and compositions of the liquid of the erosion bath, are known to a person skilled in the art.

In this way, blanks are produced in a cost-efficient and time-efficient manner. It is particularly advantageous that, in the finished endodontic instrument, the layer of the re-deposited material does not tend to crack under mechanical stress, for example during the working of a root channel. It has surprisingly been found that, contrary to the teaching of the prior art, a substantially identical hardness between the material of the rod and the layer of deposited material is particularly advantageous in this respect. Moreover, on account of the more uniform hardness (in cross section) of the blank, it is possible to obtain a very homogeneous bending behavior and particularly homogeneous elastic properties.

The rod or rods used can also be hollow rods (tubes). In the finished endodontic instrument, liquid, in particular flushing liquid, can in this way be introduced centrally into the root channel.

The material of the rods can be chosen from the following materials: α-titanium alloys; β-titanium alloys; α,β-titanium alloys; nickel-titanium alloys, in particular stoichiometric NiTi alloys or approximately equiatomic NiTi alloys, for example 50.8% Ti/49.2% Ni, 46% Ti/54% Ni. NiTi alloys can also contain additives chosen from the group consisting of niobium, copper, chromium, cobalt, hafnium, vanadium and palladium. A proportion of at least 40 atomic percent Ti is in any case preferred. With materials of this kind, both the blank and the finished endodontic instrument have superelastic properties.

The layer of the re-deposited material can have a surface hardness which is substantially 0 to 15%, preferably 0 to 8%, particularly preferably 0 to 5% harder than the hardness of the material of the at least one rod.

In the context of the invention, the surface hardness is determined in particular by the nanoindentation method. Here, an indenter is pressed with a certain force into the material. The remnant depth ratio (RDR) is used for the evaluation. This describes the ratio of the remaining penetration depth hᵥₑᵣ to the maximum penetration depth hₘₐₓ:

$$RDR = \frac{{h}_{ver}}{{h}_{max}}$$

In the machining by means of wire erosion, at least one further erosion pattern can be applied to the at least one rod. The at least one further erosion pattern is here designed such that it generates a different effect, in particular a different cutting effect, than the first erosion pattern during the intended use of the endodontic instrument. The second erosion pattern can in particular be configured reciprocally to the first erosion pattern. Accordingly, the first erosion pattern or the cutting edges thereof perform(s) a cutting function upon insertion into a root channel, and the second erosion pattern or the cutting edges thereof perform(s) a cutting function upon removal from a root channel, i.e. during the movement in the opposite direction. The root channel is efficiently cleaned and widened in this way. In particular, for example, two or three edges, in particular cutting edges, can be provided which perform a cutting action during the advance movement, i.e. upon insertion into the root channel, and one edge, in particular one cutting edge, which performs a cutting action during the reverse movement. In this way, the instrument is subject to less mechanical stress during the reverse movement. Of course, other numbers of edges, in particular of cutting edges, are also conceivable.

Advantageously, several rods can be eroded simultaneously in the method. In this way, the production process is accelerated and the production costs are lowered.

After the step of machining the one or more rods by means of wire erosion, in which step an erosion pattern is applied to the one or more rods, a secondary treatment of the one or more rods can take place. This can be done by electropolishing, chemical polishing, heat treatment for adjusting the elasticity and/or hardness, or application of a coating, in particular comprising diamond-like carbon (DLC) and/or boron nitride. The aforementioned secondary treatments can be carried out individually or in combination. In principle, any type of secondary treatment can be used that leads to a change in the properties of the blank, in particular of the cutting edges of the blank.

Of course, the one or more rods can also be pre-treated before being supplied for the method. Typical pre-treatments of the one or more rods serve to clean and/or inactivate the surface. In this way, it is possible to improve the deposition of the eroded material in the method according to the invention onto the one or more rods.

After the step of machining the one or more rods by wire erosion, in which step an erosion pattern is applied to the one or more rods, the at least one rod or the several rods can be cut into lengths. In this way, the blank is brought to the length required for the intended use and is further processed to give an endodontic instrument. In the simplest case, the further processing can simply entail the attachment of a handle. More extensive machining (for example twisting) of the actual endodontic active region is no longer necessary, as a result of which the method is considerably simplified.

A further aspect of the invention concerns a blank for an endodontic instrument. This blank is obtainable by a method as explained above. In this way, a blank is made available which is produced cost-effectively and which has the abovementioned advantages.

The invention further relates to an endodontic instrument which can be produced from a blank as described above. The endodontic instrument moreover has an attachment device (for example for a mechanical retainer for appliances or machines) and/or a holding device, in particular a handle. The endodontic instrument is mechanically more stable than conventional endodontic instruments. In particular, the re-deposited layer surprisingly does not tend to crack, on account of the material hardness being substantially identical with the body of the instrument. This applies of course to the intended use of the endodontic instrument, for example in the context of root treatment. The attachment device and/or holding device, in particular the handle, allow the instrument to be attached to a device for example during a root treatment and/or allow the instrument to be gripped by hand.

A further aspect of the invention concerns a delivery device, which is designed in such a way that several rods can be delivered simultaneously or in succession into an erosion device for carrying out a method as explained above. Advantageously, the delivery device, in combination with a device for the wire erosion, permits the introduction of one or more erosion patterns on several rods. In this way, the above-described advantages can be achieved particularly easily and efficiently.

In the delivery device, the rods can be rotated in particular through 360° and more (in particular integer multiples thereof) about the longitudinal axis of the rods. Changing the directions of rotation is also possible, in order to bring about special (e.g. contradirectional) erosion patterns.

The invention is explained below with reference to one figure and on the basis of measurement results.

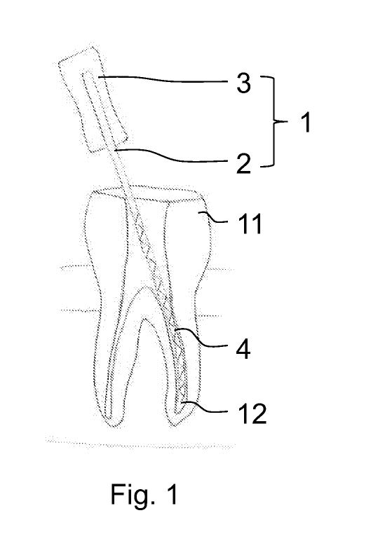

FIG. 1 shows a schematic view of an endodontic instrument in the root channel of a tooth.

FIG. 1 shows an endodontic instrument 1 during the treatment of a molar 11. Here, the endodontic instrument 1 is partially inserted into a root channel 12 of the tooth 11. By means of movements of rotation and translation, the root channel 12 is cleaned, i.e. the root removed from the root channel 12, and widened. The endodontic instrument 1 comprises a handle 3 and a body 2. The body 2 is produced from a nickel-titanium alloy and has at least one erosion pattern 4. The erosion pattern 4 was introduced in a wire erosion method. The erosion pattern 4 is formed here, inter alia, by the deposition of eroded material. The erosion pattern 4 has cutting edges, which perform a cutting function during the intended use.

The hardness of the instruments was defined by the nanoindentation method (maximum forces 10 mN and 30 mN). The remnant depth ratio (RDR) was determined for the evaluation, likewise hₘₐₓ, hᵥₑᵣ and the elastic modulus. In workpieces according to the invention, no significant difference in hardness could be identified between areas treated by EDM and areas not treated by EDM. In the endodontic application, instruments according to the invention showed excellent and homogeneous properties of bending and elasticity, without any cracking of surface material, even under intensive and prolonged stress.

1-9. (canceled)

10. A method for producing blanks for endodontic instruments, comprising the steps of:
I) providing at least one rod;
ii) machining the at least one rod by wire erosion so that a first erosion pattern is applied to the at least one rod,
wherein material eroded away from the at least one rod at least partially deposits again as a layer on the at least one rod, and the layer of the re-deposited material has a surface hardness which substantially corresponds to a hardness of the material of the at least one rod.

11. The method according to claim 10, wherein the at least one rod has a length in a range of 1 to 15 m.

12. The method according to claim 10, wherein the at least one rod has a length in a range of 2 to 10 m.

13. The method according to claim 10, wherein the at least one rod has a length in a range of 3 to 4 m.

14. The method according to claim 10, wherein the layer of the re-deposited material has a surface hardness which is substantially 0 to 15% harder than the hardness of the material of the at least one rod.

15. The method according to claim 14, wherein the layer of the re-deposited material has a surface hardness which is substantially 0 to 8% harder than the hardness of the material of the at least one rod.

16. The method according to claim 14, wherein the layer of the re-deposited material has a surface hardness which is substantially 0 to 5% harder than the hardness of the material of the at least one rod.

17. The method according to claim 10, wherein at least one further erosion pattern is applied to the at least one rod, and the at least one further erosion pattern is designed such that the at least one further erosion pattern generates a different effect than the first erosion pattern during intended use of the endodontic instrument.

18. The method according to claim 17, wherein the different effect is a different cutting effect.

19. The method according to claim 10, wherein several rods are eroded simultaneously with one another.

20. The method according to claim 10, which method, after step ii), comprises a secondary treatment of the at least one rod (2) by at least one of:
electropolishing;
chemical polishing;
heat treatment for adjusting the elasticity; and
application of a coating.

21. The method according to claim 20, wherein the applied coating comprises at least one of diamond-like carbon (DLC) or boron nitride.

22. The method according to claim 10, wherein the method comprises, after step ii), cutting the at least one rod into desired lengths.

23. A blank for an endodontic instrument, obtainable by the method according to any of claim 10.

24. An endodontic instrument which can be produced from the blank according to claim 23, wherein the endodontic instrument has at least one of an attachment device or a holding device.

25. The endodontic instrument according to claim 24, wherein the holding device is a handle.

26. A delivery device, which is designed such that several rods can be delivered simultaneously or in succession into an erosion device for carrying out the method according to claim 10.
